(19) United States
(12) Patent Application Publication
(10) Pub. No.: US 2006/0007176 A1
(43) Pub. Date: Jan. 12, 2006

(54) Input method and control module defined with an initial position and moving directions and electronic product thereof

(76) Inventor: Chung-Yi Shen, Taipei (TW)

Correspondence Address: G. LINK CO., LTD, 3550 BELL ROAD, MINOOKA, IL, 60447, US

(21) Appl. No.: 10/883,693

(22) Filed: Jul. 6, 2004

(51) Int. Cl. G09G 5/00

(52) U.S. Cl. 345/173

(57) ABSTRACT

An input method defined with an initial position and moving directions has a control module identifying different gestures on a touch control device and generating different control signals corresponding to the gestures for a main unit being used with successive control functions. A position of first contacting the touch control device is assigned as the initial position and parameter data collection is defined in the control module by the initial position and the gestures in different moving directions for being compared. The gestures generated are detected if the definition of the initial position in company with moving directions is coincided. The gestures in accordance with the definition are compared to the parameter data collection and result of comparison is output to the main unit.

### BACKGROUND OF THE INVENTION

1. Field of the Invention

The present invention is related to an input method, a control module and an electronic product thereof and particularly to an input method, a control module and an electronic product thereof defined with an initial position and moving directions to generate different control signals corresponding to different gestures for being used by a main unit in subsequent control function.

2. Brief Description of Related Art

Currently known touch control device can be roughly classified into capacitance type, resistance type, electromagnet type, pressure type, inductance type, surface sound wave type, supersonic type, photo type and etc. according to principle of physics in detecting touch control point. Actually, frequently used touch control device is belonged to capacitance type or resistance type and the touch control device is applied in a consumption electronic product such as notebook and personal digital assistant. While in use, a stylus or a finger is used to move on the touch control panel to process hand writing words or to perform touch selection function as the mouse does.

Referring to FIG. 1, U.S. Pat. No. 6,414,671 discloses a touch control device 9, which can detect capacitance change at a position on the touch control panel 90 being contacted by the finger 8 or the stylus. That is, at the moment of the finger 8 contacting the touch control panel, the touch control panel 90 generates a contact capacitance. The touch control panel 90 has an induced matrix at the surface thereof to electrically connect with an X-direction processing unit 91, a Y-direction processing unit 92 and an operation unit 93 in the touch control device 9. The X direction processing unit 91 and the Y-direction processing unit 92 can keep tracking the path of contact capacitance done by the finger 8 and the operation unit 93 can figure out location of the finger 8 with a (X,Y) coordinate parameter and can figure out Z coordinate parameter via measuring different distance changes of the finger 8 on the touch control panel 90. The operation unit 93 further sends the X, Y, Z coordinate parameters to a displacement unit 94, a gesture 95 and a transmission interface 96. The displacement unit 94 calculates the displacement increments ΔX, ΔY and sends the displacement increments ΔX, ΔY to a main unit 97 via the transmission interface 96 so as to offer relative displacements needed by the cursor of the main unit 97. The gesture unit 95 is to distinguish what gesture such as single tap, double taps, drag the finger 8 touching the touch control panel 90 is. As for the main unit 97, it can be a personal computer, a notebook computer or a portable electronic product.

Although it is convenient to perform calculation of the displacement increments ΔX, ΔY and determination of gesture input type, the preceding method is only suitable for providing relative displacements needed by the cursor of the conventional window software and U.S. Pat. No. 6,414,671 has very limited application.

### SUMMARY OF THE INVENTION

The crux of the present invention is to allow the touch control device being capable of providing versatile control functions with more extensive use.

Accordingly, an object of the present invention is to provide an input method defined by an initial position and moving directions to generate different control signals corresponding to different gestures for a main unit being capable of using subsequent control functions.

Another object of the present invention is to provide a control module, which can convert gestures defined by an initial position and moving directions into different control signals for a main unit being capable of using subsequent control functions.

A further object of the present invention is to provide an electronic product defined by an initial position and moving directions and performing multiple control functions according to different gestures.

The input method of the present invention defined with an initial position and moving directions has a control module identifying different gestures on a touch control device and generating different control signals corresponding to the gestures for a main unit using subsequent control functions. A position of first contacting the touch control device is assigned as the initial position and parameter data collection is defined in the control module by the initial position and the gestures in different moving directions for being compared. Gestures generated are detected if the definition of the initial position in company with moving directions is coincided. The gestures in accordance with the definition are compared with the parameter data collection and result of comparison is output to the main unit.

The control module of the present invention, which is electrically connected to a touch control device and a main unit for identifying gestures of an initial position in company with different moving directions on the touch control device and supplying different control signals for being used by the main unit. The control module includes a coordinate processing unit electrically connected to the touch control device, a parameter memory unit with a parameter data collection therein for being compared with, an operation unit electrically connected to the coordinate processing unit and the parameter memory unit and a transmission interface electrically connected to the main unit.

The coordinate processing unit receives and converts the gestures on the touch control device into corresponding coordinate parameters. The operation unit assigns an initial position, which is the first position being touched on the touch control device, with moving directions of the gesture being looked up as a criterion of determination and the coordinate parameter received by the coordinate processing unit being compared with parameter saved in the parameter data collection so as to output the control signal corresponding to the gesture. The transmission interface sends the control signal generated by the operation unit to the main unit.

The electronic product of the present invention includes a main unit, a touch control device electrically connected to the main unit; and a control module electrically connected to the main unit and the touch control device for identifying gestures of an initial position in company with different moving directions on the touch control device and offering different control signals for being used by the main unit.

The control module includes a coordinate processing unit electrically connected to the touch control device, a parameter memory unit with a parameter data collection therein for being compared with, an operation unit electrically connected to the coordinate processing unit and the parameter memory unit and a transmission interface electrically connected to the main unit.

The coordinate processing unit receives and converts the gestures on the touch control device into corresponding coordinate parameters. The operation unit assigns an initial position, which is the first position being touched on the touch control device, with moving directions of the gesture being looked up as a criterion of determination and the coordinate parameter received by the coordinate processing unit being compared with parameter saved in the parameter data collection so as to output the control signal corresponding to the gesture. The transmission interface sends the control signal generated by the operation unit to the main unit.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a block diagram illustrating components of currently used touch control device and function thereof;

FIG. 2 is a plan view illustrating a method of input according to the present invention in a first embodiment thereof which is based on the position of first touch P1 with a first moving direction and a second moving direction;

FIG. 3 is a plan view illustrating a method of input according to the present invention in a second embodiment thereof which is based on the position of first touch P2 with a third moving direction and a fourth moving direction in addition to the first and the second moving directions shown in FIG. 2;

FIG. 4 is a plan view illustrating a method of input according to the present invention in a third embodiment thereof which is based on the position of first touch P3 with a fifth moving direction, a sixth moving direction and an eighth moving direction in addition to the first, second, third and fourth moving directions shown in FIG. 3;

FIG. 5 is a plan view illustrating a method of input according to the present invention in a fourth embodiment thereof which is based on the position of first touch P4 with a ninth moving direction and a tenth moving direction and the ninth moving direction turns clockwise and the tenth moving direction turns counterclockwise;

FIG. 6 is a plan view illustrating the method of input associated with the first, second and third embodiments being used in an electronic product;

FIG. 7 is a block diagram illustrating the electronic product shown in FIG. 6 being composed of a touch control device, a control module and a main unit and the touch control device being provided with a first zone, a second zone and a third zone;

FIG. 8 is a plan view illustrating the method of input associated with the second and the fourth embodiments being used in another electronic product; and

FIG. 9 is a block diagram illustrating the electronic product shown in FIG. 8 being provided with a touch control device, a control module and a main unit and the touch control device is arranged a fourth zone and a fifth zone.

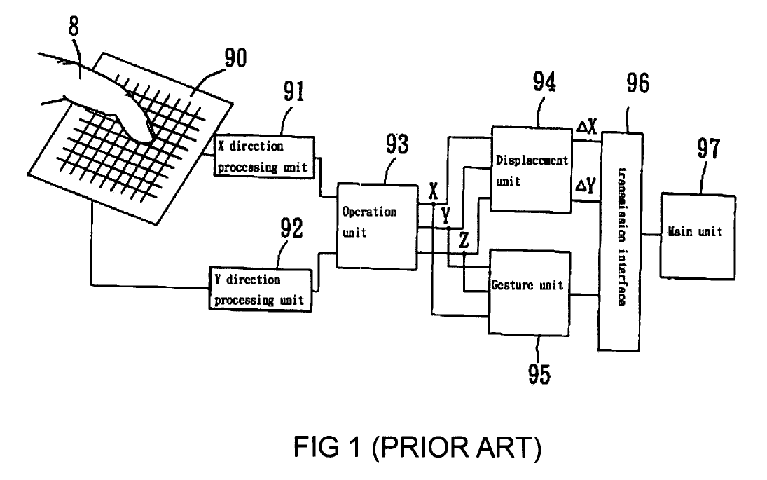

### DETAILED DESCRIPTION OF THE PREFERRED EMBODIMENTS

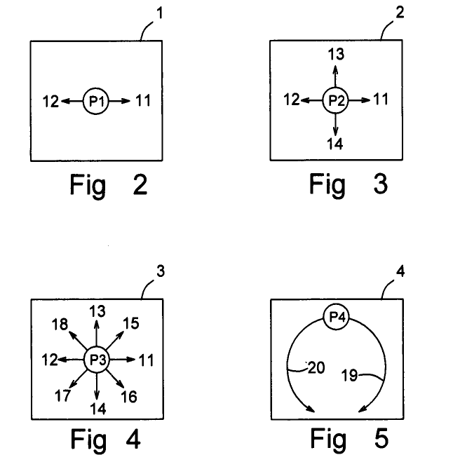

Referring to FIG. 2, the first embodiment of a method of input according to the present invention provides an initial position P1, which is the first touched position of the touch control device, in company with a first moving direction 11 and a second moving direction 12. The first and second moving directions 11, 12 extend along an axis, which is originated from the initial position P1, in a way of being opposite to each other.

It is noted that the first touch position of a finger or an object on the touch control device 1 is identified as the initial position in the present preferred embodiment and the subsequent preferred embodiments of the present invention. That is, any spot of the touch control device 1 can be identified as the initial position P1. Hence, once the preceding definition of the initial position P1 is satisfied, movements along with the first moving direction 11 and the second moving direction 12 are looked up as effective control movements.

Referring to FIG. 3, the second embodiment of a method of input according to the present invention is illustrated. An initial position P2, which is figured out at the first touch, is defined as a basis in company with a third moving direction 13 and a fourth moving direction 14 in addition to the first moving direction 11 and the second moving direction 12. The first and second moving directions 11, 12 are based on the initial position P2 to extend along an axis in a way of the first and second moving directions 11, 12 being opposite to each other. The third and fourth moving directions 13, 14 are based on the initial position P2 to extend oppositely in way of being perpendicular to the axis.

The first touch of either a finger or an object on the touch control device 2 is identified as the initial position P2. Once the definition of the initial position P2 is satisfied, movements from the initial position P2 in the first moving direction 11, second moving direction 12, third moving direction 13 and fourth moving direction are looked up as effective control movements.

Referring to FIG. 4, the third preferred embodiment of the present invention is illustrated. An initial position P3, which is measured at the first touch, is defined as a basis in company with a fifth moving direction 15, a sixth moving direction 16, a seventh moving direction 17 and an eighth moving direction in addition to the first moving direction 11, the second moving direction 12, the third moving direction 13 and the fourth moving direction 14.

Wherein, the fifth moving direction 15 is disposed between the first moving direction 11 and the third moving direction 13, the sixth moving direction 16 is disposed between the first moving direction 11 and the fourth moving direction 14, the seventh moving direction is disposed between the second moving direction 12 and the fourth moving direction 14 and the eight moving direction is disposed between the second moving direction 12 and the third moving direction. After an actual test, a great control effect can be obtained in case of an angle between two adjacent moving directions being in a range of 30° and 45°.

The first touch of either a finger or an object on the touch control device 3 is identified as the initial position P3. Once the definition of the initial position P3 is fulfilled, movements from the initial position P3 in the first moving direction 11, second moving direction 12, third moving direction 13, fourth moving direction 14, fifth moving direction 15, fifth moving direction 16, seventh moving direction 17 and eighth moving direction are looked up as effective control movements.

Referring to FIG. 5, the third preferred embodiment of the present invention is illustrated. An initial position P4, which is measured at the first touch, is defined as a basis in company with a ninth moving direction 19 and a tenth moving direction 20 and the ninth moving direction 19 is a clockwise direction and the tenth moving direction is a counterclockwise direction. The first touch of either a finger or an object on the touch control device 2 is identified as the initial position P4. Once the definition of the initial position P4 is fulfilled, movements from the initial position P4 in the ninth moving direction 11 and the tenth moving direction are looked up as effective control movements.

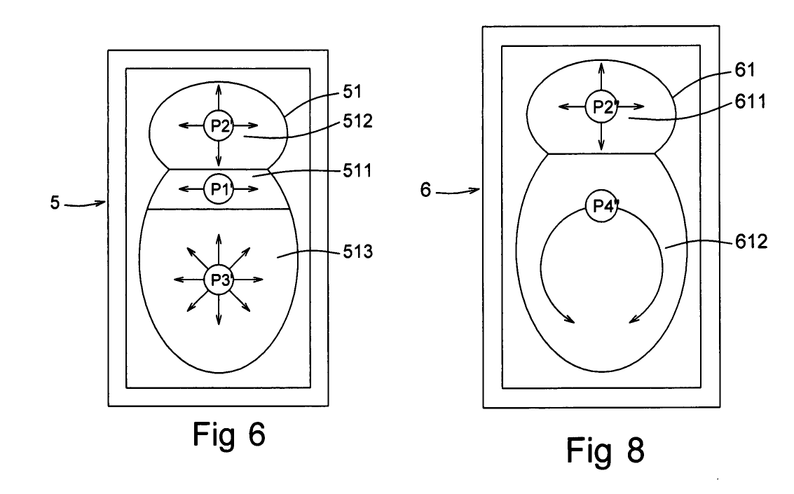

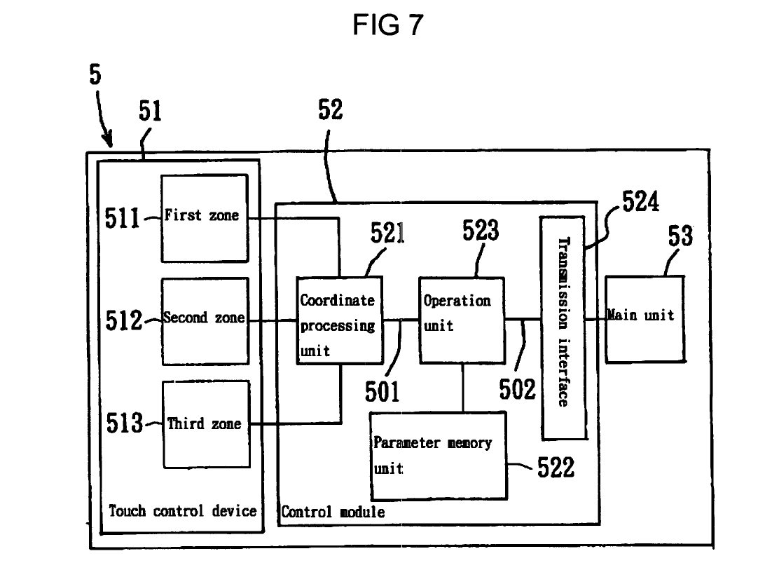

Referring to FIGS. 6 and 7, an example of an electronic product 5 associated with a method of input in the first, the second the third and the fourth preferred embodiments is illustrated. The electronic product 5 can be divided into a plurality of zones on the touch control device 51 thereof and the zones are a first zone 511, a second zone 512, a third zone 513. Besides, the electronic product 5 provides a control module 52 therein to electrically connect with the touch control device 51 and a main unit 53. The control module 52 is used for identifying the initial positions P1, P2 and P3 produced at the first, second and third zones respectively joining with gestures of different moving directions and to generate different control signals 502 for control of the main unit 53. As for the initial positions P1, P2 and P3 joining with gestures of different moving directions, which have been illustrated in FIGS. 2, 3 and 4, no detail will be explained further.

The electronic product 5 in the example can be a touch type remote controller and can identify different initial positions with gestures in different moving directions. Further, the control signal 520 generated by the remote controller can allow the main unit 53 to provide remote control function for item selections of the main menu and multiple media control items such as channel adjustment and volume adjustment. As for the arranged first zone 511, second zone 512 and third zone 513, the generated control item with the output control signal 502 thereof corresponding to the initial positions P1′, P2′ and P3′ with gestures of different moving directions are listed in table 1.

TABLE 1

| Position + Gesture | Control Item Instruction | Control Signal |
|---|---|---|
| P1′ + double taps | Return to main menu | 00000001 |
| P1′ + single tap | selected | 00000010 |
| 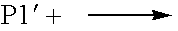 | Move to right | 00000011 |
| 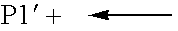 | Move to left | 00000100 |
| 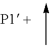 | Move up | 00000101 |
| 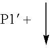 | Move down | 00000110 |
| 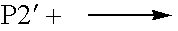 | Contrast increase | 00000111 |
| 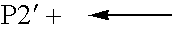 | Contrast decrease | 00001000 |
| 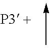 | Channel increase successively | 00001001 |
| 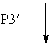 | Channel decrease successively | 00001010 |
| 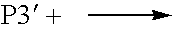 | Volume increase | 00001011 |
| 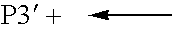 | Volume decrease | 00001100 |
| 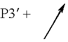 | Power source | 00001101 |
| 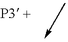 | silence | 00001110 |
| 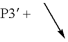 | Brightness increase | 00001111 |
| 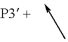 | Brightness decrease | 00010000 |
| P3′ + single tap | If located at the button, button | 00010001 |
| | signal is output | |
| P3′ + single tap | If not located at the button, it is | |
| | ineffective. | |
| P3′ + single tap | Enter | 00010010 |

The control module 52 in the electronic product 5 has a coordinate processing unit 521, a parameter memory unit 522 with preset parameter data collection for comparison, an operation unit 523 electrically connected to the coordinate processing unit 521 and the parameter memory unit 522 and a transmission interface 524 electrically connected to the main unit 53. The coordinate processing unit 521 receives gestures on the touch control device 51 and converts the gestures into a coordinate parameter 501. The operation unit 523 assigns an initial position, which is the first position being touched on the touch control device 51, and the initial position paring with moving direction of the gesture is made as a criterion of determination. The coordinate parameter received by the coordinate processing unit 521 is compared with parameter saved in the parameter data collection so that the control signal 502 corresponding to the gesture can be output. Further, the transmission interface 524 sends the control signal 502 generated by the operation unit 523 to the main unit 53.

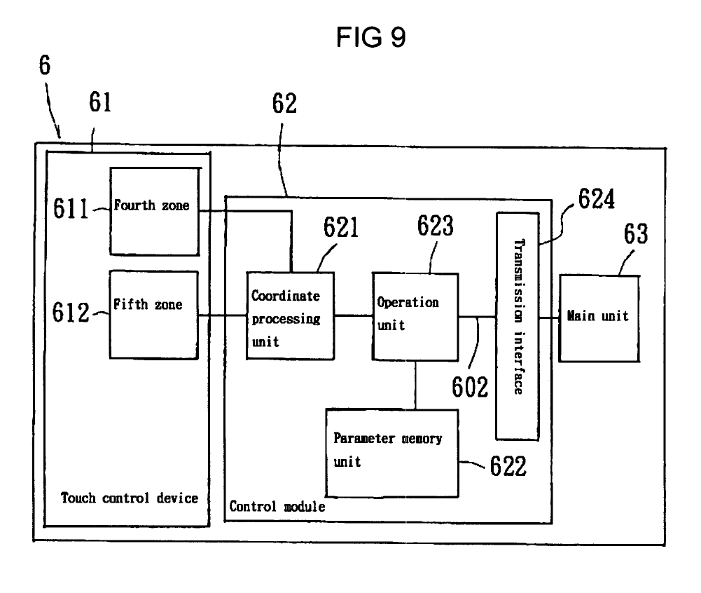

Referring to FIGS. 8 and 9, an example of an electronic product 6 associated with a method of input in the second and the fourth preferred embodiments is illustrated. The electronic product 6, which is a touch control remote controller too, includes a touch control device 61 and a control module 62. The connecting way of the control module 62 to the main unit 63 and related functions of the control module 62 are similar to the preceding electronic product 5 and the touch control device 61 of the electronic product 6 is divided into a plurality of zones too. The difference of the touch control device 61 from the touch control device 51 is in that the zones are a fourth zone 611 and a fifth zone 612 and the control module 62 generates different control signals 602 corresponding to initial positions P2″ and P4″ with gestures in different moving directions for successive control of the main unit 63. As for the initial positions P2″ and P4″ with gestures of different moving directions, which have been illustrated in FIGS. 3 and 5, no detail will be explained further.

The arranged fourth zone 611 and the fifth zone 612, the generated control item with the output control signal 502 thereof corresponding to the initial positions P2″ and P4″ with gestures of different moving directions are listed in table 2.

TABLE 2

| Position + Gesture | Control item instruction | Control signal |
|---|---|---|
| P2″ + single tap | selected | 00000001 |
| P2″ + double taps | Return to main menu | 00000010 |
| P2″ + → | Move to right | 00000011 |
| P2″ + ← | Move to left | 00000100 |
| P2″ + ↑ | Move up | 00000101 |
| P2″ + ↓ | Move down | 00000110 |
| P4″ + turning clockwise | Channel increase | 00000111 |
| P4″ + turning | Channel decrease | 00001000 |
| counterclockwise | | |
| P4″ + single tap | Enter | 00001001 |
| P4″ + single tap | If located at the button, | 00001010 |
| | button signal is output | |

It is noted that the electronic products 5, 6 can be any electronic devices, which provides control function by way of a method of touch control type input. It can be done with the control module 52, 62 being connected to the touch control device to output actually applicable control signals for being joined to different main units so that multiple control functions can be implemented.

It is appreciated that comparing to the conventional input way, which offers relative displacement needed by the cursor of the ordinary window software, being very limited in application, the present invention provides a method of input, a control module and an electronic product with which the touch control device can be divided into a plurality of zones and each zone is suitable for operating the method of input of the present invention in addition to providing initial position of gesture, defining moving direction and outputting different control signals. Hence, the present invention allows the touch control device to offer more versatile control functions so as to expand the applicable field thereof.

While the invention has been described with referencing to the preferred embodiments thereof, it is to be understood that modifications or variations may be easily made without departing from the spirit of this invention, which is defined by the appended claims.

What is claimed is:

1. An input method defined with an initial position and moving directions, having a control module identifying different gestures on a touch control device and generating different control signals corresponding to the gestures for a main unit being used with successive control functions, comprising the following steps:
A) a position of first contacting the touch control device being assigned as the initial position and parameter data collection is defined in the control module by the initial position and the gestures in different moving directions for being compared;
B) detecting if there are gestures generating and coinciding the definition of contacting the initial position in company with moving directions in step A); and
C) comparing the gestures in accordance with the definition in step A) to the parameter data collection and outputting result of comparison to the main unit.

2. The input method defined with an initial position and moving directions as defined in claim 1, wherein the initial position in step A) is a basis with a first moving direction and a second moving direction extending along an axis in a way of being opposite to each other and a parameter data collection corresponding to the gestures, which move along the first and second moving directions from the initial position, being defined in the control module.

3. The input method defined with an initial position and moving directions as defined in claim 2, wherein the initial position is a basis in company with a third moving direction and a fourth moving direction, which are opposite to each other, extending perpendicular to the axis and a parameter data collection corresponding to the gestures, which move along the third and fourth moving directions from the initial position, being defined in the control module.

4. The input method defined with an initial position and moving directions as defined in claim 3, wherein the initial position is an origin with the first moving direction extending to the right of the origin, the second moving direction extending to the left of the origin, the third moving direction extending upward from the origin and the fourth moving direction extending downward from the origin.

5. The input method defined with an initial position and moving directions as defined in claim 3, wherein the initial position is a basis in company with a fifth moving direction, a sixth moving direction, a seventh moving direction and an eighth direction in addition to being company with the first, second, third and fourth moving directions in a way of the fifth moving direction being disposed between the first and the third moving directions, the sixth direction being disposed between the first and the fourth moving directions, the seventh moving direction being disposed between the second and the fourth moving directions and the eighth moving direction being disposed between the second and the third moving directions.

6. The input method defined with an initial position and moving directions as defined in claim 5, wherein an angle between any adjacent two of the first, second, third, fourth, sixth, seventh and eighth moving directions being in a range of 30° and 45°.

7. The input method defined with an initial position and moving directions as defined in claim 2, wherein the initial position is a basis in company with a ninth moving direction and a tenth moving direction in a way of the ninth moving direction being a clockwise direction and the tenth moving direction being a counterclockwise direction and a parameter data collection corresponding to the gestures, which move along the ninth and tenth moving directions from the initial position, being defined in the control module.

8. A control module, electrically connected to a touch control device and a main unit for identifying gestures of an initial position in company with different moving directions on a touch control device and offering different control signals for control of the main unit, comprising:
a coordinate processing unit, being electrically connected to the touch control device to receive and convert the gestures on the touch control device into corresponding coordinate parameters;
a parameter memory unit, providing a parameter data collection therein for being compared with;
an operation unit, being electrically connected to the coordinate processing unit and the parameter memory unit, assigning an initial position, which is the first position being touched on the touch control device, the initial position with moving directions of the gesture being looked up as a criterion of determination, the coordinate parameter received by the coordinate processing unit being compared with parameter saved in the parameter data collection so as to output the control signal corresponding to the gesture; and
a transmission interface, being connected to the main unit to send the control signal generated by the operation unit to the main unit.

9. The control module as defined in claim 8, wherein the initial position is assigned as a basis with a first moving direction and a second moving direction extending along an axis in a way of being opposite to each other and a parameter data collection corresponding to the gestures, which move along the first and second moving directions from the initial position, being defined in the parameter memory unit.

10. The control module as defined in claim 9, wherein the initial position is a basis in company with a third moving direction and a fourth moving direction, which are opposite to each other, extending perpendicular to the axis and a parameter data collection corresponding to the gestures, which move along the third and fourth moving directions from the initial position, being defined in the parameter memory unit.

11. The control module as defined in claim 10, wherein the initial position is an origin with the first moving direction extending to the right of the origin, the second moving direction extending to the left of the origin, the third moving direction extending upward from the origin and the fourth moving direction extending downward from the origin and a parameter data collection corresponding to the gestures, which move along the third and fourth moving directions from the initial position, being defined in the parameter memory unit.

12. The control module as defined in claim 9, wherein the initial position is a basis in company with a fifth moving direction, a sixth moving direction, a seventh moving direction and an eighth direction in addition to being company with the first, second, third and fourth moving directions in a way of the fifth moving direction being disposed between the first and the third moving directions, the sixth direction being disposed between the first and the fourth moving directions, the seventh moving direction being disposed between the second and the fourth moving directions and the eighth moving direction being disposed between the second and the third moving directions and a parameter data collection corresponding to the gestures, which move along the fifth, sixth, seventh and eighth moving directions from the initial position, being defined in the parameter memory unit.

13. The control module as defined in claim 12, wherein the initial position is a basis with an angle between any adjacent two of the first, second, third, fourth, sixth, seventh and eighth moving directions being in a range of 30° and 45°.

14. The control module as defined in claim 12, wherein the initial position is a basis with a ninth moving direction and a tenth moving direction in a way of the ninth moving direction being a clockwise direction and the tenth moving direction being a counterclockwise direction and a parameter data collection corresponding to the gestures, which move along the ninth and tenth moving directions from the initial position, being defined in the parameter memory unit.

15. An electronic product, comprising:
a main unit;
a touch control device, being electrically connected to the main unit; and
a control module, being electrically connected to the main unit and the touch control device for identifying gestures of an initial position in company with different moving directions on the touch control device and offering different control signals for control of the main unit;
wherein, the control module further comprises:
a coordinate processing unit, being electrically connected to the touch control device to receive and convert the gestures on the touch control device into corresponding coordinate parameters;
a parameter memory unit, providing a parameter data collection therein for being compared with;
an operation unit, being electrically connected to the coordinate processing unit and the parameter memory unit, assigning an initial position, which is the first position being touched on the touch control device, the initial position with moving directions of the gesture being looked up as a criterion of determination, the coordinate parameter received by the coordinate processing unit being compared with parameter saved in the parameter data collection so as to output the control signal corresponding to the gesture; and
a transmission interface, being connected to the main unit to send the control signal generated by the operation unit to the main unit.

16. The electronic product as defined in claim 15, wherein the control module assigns the initial position as a basis with a first moving direction and a second moving direction extending along an axis in a way of being opposite to each other and a parameter data collection corresponding to the gestures, which move along the first and second moving directions from the initial position, being defined in the parameter memory unit.

17. The electronic product as defined in claim 15, wherein the control module assigns the initial position as a basis in company with a third moving direction and a fourth moving direction, which are opposite to each other, extending perpendicular to the axis and a parameter data collection corresponding to the gestures, which move along the third and fourth moving directions from the initial position, being defined in the parameter memory unit.

18. The electronic product as defined in claim 17, wherein the control module assigns the initial position being an origin with the first moving direction extending to the right of the origin, the second moving direction extending to the left of the origin, the third moving direction extending upward from the origin and the fourth moving direction extending downward from the origin.

19. The electronic product as defined in claim 17, wherein the control module assigns the initial position as a basis in company with a fifth moving direction, a sixth moving direction, a seventh moving direction and an eighth direction in addition to being company with the first, second, third and fourth moving directions in a way of the fifth moving direction being disposed between the first and the third moving directions, the sixth direction being disposed between the first and the fourth moving directions, the seventh moving direction being disposed between the second and the fourth moving directions and the eighth moving direction being disposed between the second and the third moving directions and a parameter data collection corresponding to the gestures, which move along the fifth, sixth, seventh and eighth moving directions from the initial position, being defined in the parameter memory unit.

20. The electronic product as defined in claim 19, wherein the control module assigns the initial position as a basis with an angle between any adjacent two of the first, second, third, fourth, sixth, seventh and eighth moving directions being in a range of 30° and 45°.

21. The electronic product as defined in claim 15, wherein the control module assigns the initial position as a basis with a ninth moving direction and a tenth moving direction in a way of the ninth moving direction being a clockwise direction and the tenth moving direction being a counterclockwise direction and a parameter data collection corresponding to the gestures, which move along the ninth and tenth moving directions from the initial position, being defined therein.

22. The electronic product as defined in claim 15 is a remote controller for identifying gestures of the initial position with different moving direction and control signals generated by the remote controller are for the main unit providing control functions such as item selection, channel increase and decrease and volume increase and decrease.

23. The electronic product as defined in claim 15, wherein the touch control device is divided into a plurality of zones for the main unit providing multiple control functions.
